(19) United States
(12) Patent Application Publication
(10) Pub. No.: US 2024/0367423 A1
(43) Pub. Date: Nov. 7, 2024

(54) RECYCLABLE POLYETHYLENE COLD SEAL FILM FOR FOOD PACKAGING

(71) Applicant: General Mills, Inc., Minneapolis, MN (US)

(72) Inventors: Brian Grant, Richfield, MN (US); George A. Tuszkiewicz, River Falls, WI (US)

(21) Appl. No.: 18/654,106

(22) Filed: May 3, 2024

Related U.S. Application Data
(60) Provisional application No. 63/463,693, filed on May 3, 2023.

(51) Int. Cl. B32B 27/08; B32B 7/06; B32B 7/12; B32B 27/32; B65B 9/08; B65B 41/12; B65B 51/30; B65D 65/40; C09J 7/24; C09J 7/40; C09J 9/00

(52) U.S. Cl. CPC B32B 27/08; B32B 7/06; B32B 7/12; B32B 27/32; B65B 9/08; B65B 41/12; B65B 51/30; B65D 65/40; C09J 7/243; C09J 7/401; C09J 9/00; B32B 2255/10; B32B 2307/30; B32B 2307/4023; B32B 2307/514; B32B 2307/7376; B32B 2307/748; B32B 2439/70; C09J 2423/005; C09J 2423/006

(57) ABSTRACT

A polyethylene cold seal film includes a main body layer constituted by a polyethylene film, a cold seal adhesive externally exposed on one side of the main body layer, and a cold seal release layer externally exposed on an opposing side of the main body layer, with the cold seal release layer also being constituted by a polyethylene film. The film can be advantageously provided in roll form, particularly usable in wrapping food products, with the wrapping being completely and readily recyclable, while being at least essentially void of any polypropylene polymers. The overall film can also have other layers, including a tie layer positioned between the main body layer and the cold seal release layer, a barrier layer positioned between the main body layer and the tie layer; and an ink layer positioned between the tie layer and the cold seal release layer.

### CROSS-REFERENCE TO RELATED APPLICATION

This application claims the benefit of U.S. Provisional Application No. 63/463,693, filed May 3, 2023.

### FIELD OF THE INVENTION

The invention generally pertains to the art of packaging and, more particularly, to packaging food products in polyethylene cold seal film packages suitable for recycling.

### BACKGROUND OF THE INVENTION

Employing flexible film for packaging a wide range of food and other products is widely known. In particular, packaging systems employing films include, but not limited to, vertical form, fill and seal (VFFS) packaging systems, horizontal form, fill and seal (HFFS) packaging systems and horizontal flow wrap (HFW) packaging systems which are often used in packaging various food snacks, including cereal, potato chips, power bars, breakfast bars, and the like. Typically, these packaging systems rely on wrapping food products in a flexible film taken from a roll, with overlapping longitudinal edge portions of the film being sealed together, such as along a back seal, while opposing transverse end seals are created to sealingly encapsulate the food products. One or more packaged products are often further packaged in a box for shipment to a retail store in order to be sold to consumers.

Collectively, all of these known packaging systems could be generically referred to as film flow packaging systems. Flexible packaging film for food and other products is most typically sealed by seal assemblies using jaw units each including opposing jaw heads which sandwich the film(s) in order to bond the film layers together. This bonding operation can be performed in various ways, typically either by the transfer of heat to the packaging material through the jaws in order to melt and weld multiple film layers together or through the use of films including cold seal adhesives which allow the package to be sealed just with pressure, i.e., the sealing operation does not require heat. In the case of cold sealing, to which the present invention is directed, a cold seal adhesive layer or pattern is provided on one side of a main film body and a cold seal release layer is provided on the opposing side of the main film body. In this manner, the cold seal adhesive and cold seal release layers contact each other when the film is in a roll form, thereby enabling the rolled film to be easily unrolled during packaging.

The films employed in at least the food packaging field are laminates, mainly consisting of polypropylene (specifically biaxially oriented polypropylene or BOPP), polyethylene (specifically biaxially oriented polyethylene or BOPE), polyethylene terephthalate (PET) or a combination thereof. The cold seal adhesive layer or cold seal adhesive pattern is typically a latex, synthetic based or a combination of both, and the cold seal release layer has historically been constituted by a lacquer coating, such as a polyamide-type lacquer. However, advancements have resulted in laminate packaging films which employ a film layer as the cold seal release layer. Unfortunately, even with these advancements, these available film structures are not recyclable.

With the above in mind, there is seen to be a need for a flexible film laminate, particularly available in roll form for the food packaging industry, which employs at least a main film body layer, a cold seal adhesive layer and a cold seal release film layer, with overall package being completely recyclable.

### SUMMARY OF THE INVENTION

In accordance with the invention, a flexible laminate packaging film is specifically formed from only materials which can be readily recycled, specifically post consumer recycled (PCR). More specifically, the overall film of the invention includes a main laminate body constituted by a polyethylene film layer with optional metallic barrier and/or ink layers, a cold seal adhesive on one side surface of the main laminate body and a cold seal release film on an opposing side of the main laminate body, wherein the entire film is made from recyclable materials. In particular, the film employs both a polyethylene main body and a polyethylene cold seal release film layer, while being at least essentially void of, and preferably entirely void of, polypropylene, thereby being significantly advantageous in establishing a readily recyclable, overall film. The film can advantageously be provided in roll form for use in a film flow food packaging system to establish wrappings which envelop products in a manner wherein the entire wrapping can be readily, post consumer recycled which requires, in accordance with the invention, the film to meet various specific criteria.

Additional objects, features and advantages of the invention will become more readily apparent from the following detailed description, when taken in conjunction with the drawings wherein like reference numerals refer to corresponding parts in the several views.

### BRIEF DESCRIPTION OF THE DRAWINGS

FIG. 1 illustrates an exemplary vertical form, fill and seal packaging system employing the recyclable laminate polyethylene cold seal film of the invention; and

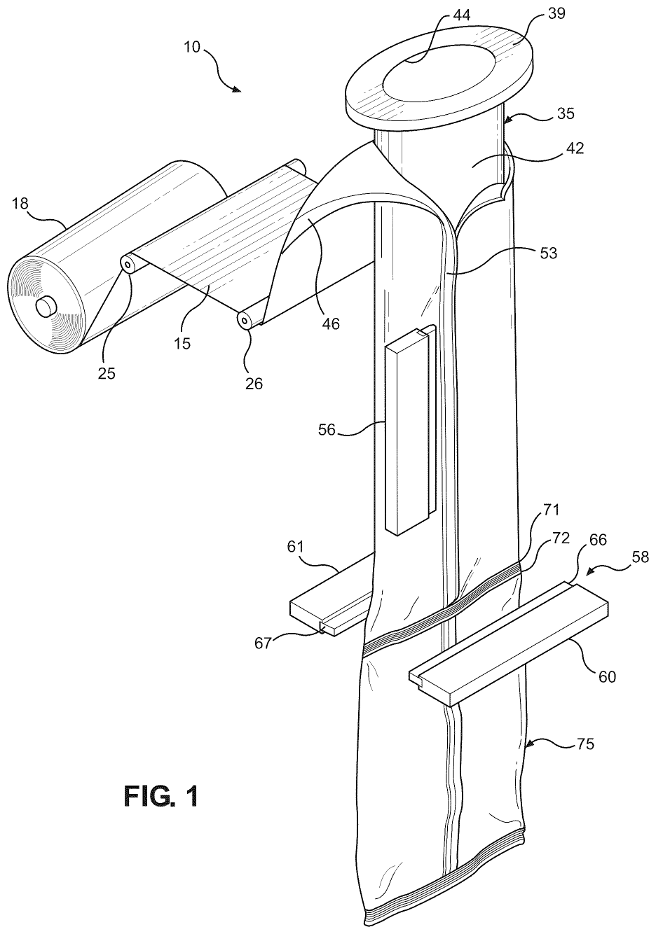

FIG. 2 is a cross-sectional view of the layers of the recyclable laminate polyethylene cold seal film of FIG. 1.

### DETAILED DESCRIPTION OF THE INVENTION

Although employable in many environments and in many packaging systems, the recyclable laminate polyethylene cold seal film of the invention will be described with respect to its application to a vertical form, fill and seal (VFFS) food packaging system generally indicated at 10. At this point, it should be understood that VFFS system 10 is only presented for exemplary purposes and the invention can be employed in various other known packaging systems including, but not limited to, horizontal form, fill and seal (HFFS) packaging systems and horizontal flow wrap (HFW) packaging systems. Packaging system 10 employs a sheet of flexible film 15 which is constructed in accordance with the invention and initially supplied from a roll 18. Although detailed and defined more fully below, sheet 15 constitutes a laminate cold seal polyethylene film that is completely recyclable. From roll 18, sheet 15 is guided about a plurality of tensioning elements 25, 26 and directed to a product delivery tube 35. As shown, product delivery tube 35 includes an upper flange 39, a tubular body 42 and an upper product delivery opening 44 enabling items, such as food snack pieces (not shown), to be supplied into tubular body 42.

Although not shown, one or more drive units, such as film engaging belts, are employed to continually feed sheet 15 about a shaping member or guide 46 in order to wrap sheet 15 about tubular body 42 which can take various geometric shapes, including circular and oval shapes. In connection with wrapping sheet 15, a longitudinal seam 53 is established in alignment with a vertical seamer 56, thereby creating open ended tubular packaging. Thereafter, the shaped and vertically sealed sheet 15 proceeds to a jaw 58 shown constituted by first and second jaw members 60 and 61 which extend generally horizontally on opposing sides of sheet 15. While vertical seamer 56 operates by applying pressure to layers of sheet 15 against guide 46 to join the polyethylene film or sheet 15 to itself to create a longitudinal seal, jaw members 60 and 61 include respective heads 66 and 67 which operate to clamp and apply pressure to sheet 15 to simultaneously create a transverse seal which is subsequently cut to establish a first seal 71 for the lower end of the tubular packaging and a second seal 72 for the upper end of a packaged product 75 containing the food pieces introduced through opening 44 and tubular body 42.

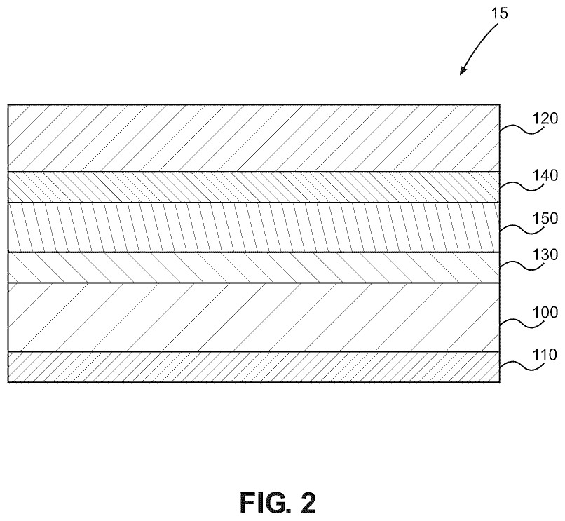

Again, the invention is particularly directed to the construction of the sheet of film 15 which enables sheet 15 to be readily recycled as will now be described with specific reference to FIG. 2. In accordance with the invention, sheet 15 constitutes a laminate polyethylene cold seal film including, at a minimum, a main body layer 100 constituted by a polyethylene film, a cold seal adhesive 110 (continuous or patterned) externally exposed on one side of main body layer 100 and a cold seal release layer 120 which is also constituted by a polyethylene film and is externally exposed on an opposing side of main body layer 100. At this point, it should be understood that, in referring to main body layer 100 as a polyethylene film, it is meant that main body layer 100 is void of any polymer which would render the film not readily recyclable (as defined below), in particular at least essentially void of (less than 10%) and, more preferably, completely void of polypropylene polymers in the film. The same is true for cold seal release layer 120. However, in referring to either as a “layer” does not mean that each cannot be a laminate with multiple sub-layers. In accordance with certain embodiments of the invention, main body layer 100 is a polyethylene (PE) film, such as oriented polyethylene (OPE), biaxially oriented polyethylene (BOPE), machine direction oriented polyethylene (MDOPE), Blown PE or Cast PE, preferably with a thickness in the range of 60-200 gauge. Cold seal adhesive 110 is preferably constituted by a latex, synthetic based or a combination of both cold seal adhesive. More importantly, as indicated above, cold seal release layer 120 takes the form of a film, rather than a coating, and is formed of polyethylene, thereby being void of any polymer which would render cold seal release layer 120 not readily recyclable (as defined below), in particular at least essentially void of (less than 10%) and, more preferably, completely void of polypropylene polymers in the film of cold seal release layer 120. In certain embodiments, cold seal release (CSR) layer 120 is an oriented polyethylene film, such as CSR OPE, CSR BOPE or CSR MDOPE, Blown PE or Cast PE provided in a thickness range of 60-130 gauge.

In accordance with the embodiment shown in FIG. 2, the sheet of film 15 also includes a barrier layer 130 such as formed from a metallic material like aluminum, aluminum oxide, silicon oxide, ethylene vinyl alcohol (EVOH) and/or polyvinyl alcohol (PVOH). Such a barrier layer 130 is known in the art in connection packaging certain food products such as snack and power bars. Barrier layer 130 is shown directly upon main body layer 100 and connected to an ink layer 140 through a tie or lamination adhesive layer 150. In a manner also known in the art, ink layer 140 is used to convey specific product related information, with ink layer 140 typically being solvent or aqueous based. On the other hand, tie layer 150 constitutes an adhesive coating (single layer or lamination) or a polymer extrudate disposed between and interconnecting barrier layer 130 and ink layer 140. For the sake of completeness, tie layer 150 can be applied at about 1 lb/ream-1.5 lb/ream as an adhesive coating, or 0.5 mil-1.0 mil as an extrudate.

As mentioned above, film 15 is preferably provided in roll form for use in a film flow packaging system to establish wrappings which envelop products, particularly food products, wherein the entire wrapping is readily recyclable. At this point, it should be noted that recyclability is measured according to standard testing protocol, particularly APR Critical Guidance Protocol FPE-CG-01. Important in accordance with the invention, constituting an entirely, “readily recyclable” film requires the film to meet various criteria. That is, constituting a recyclable material can take various meanings in the art, even inclusive of a material which can be reformed into an extrudable product that is not functional for its original purpose (often referred to as down recycling). Also, various materials can be recycled only through chemical processing. In accordance with the present invention, “readily recyclable” means film 15 can be mechanically recycled according to ISO standards back to a PE film usable for its original purpose. In addition, it is important to recognize that this definition must encompass post consumer recycling, i.e., where the film is collected through consumers and recycled (Post Consumer Recycled or PCR) according to ISO standards, particularly ISO 14021:2016 Section 7.8.1. That is, it is not enough for excess material during original film manufacturing to be easily recycled, but rather the film must be recyclable after film 15 is used to package a product and the product wrapper is later sent for recycling by a consumer. To meet these specifically defined criteria, as indicated above, it is important that the entire film be void of any polymer which would render the film not readily recyclable, particularly at least essentially void of (i.e., less than 10%) and, more preferably, completely void of polypropylene in the film, as this enhances the ease of recycling given the differences in known melting temperatures of polypropylene (about 320° F.) versus polyethylene (less than 270° F.).

When in roll form, it should be clear that cold seal release layer 120 is in direct engagement with cold seal adhesive 110. Providing cold seal release layer 120 as a film has many advantages. For instance, the extra drying time needed in connection with a varnish or lacquer coating is avoided when making the film, and the film does not develop problematic curling issues as is common with prior art coatings. Still, it is important that the cold seal adhesive 110 does not stick to the cold seal release layer 120 so as to hamper the smooth unrolling of the packaging film. In accordance with the invention, it has been found that the polyethylene cold seal release layer 120 provides superior peel release to conventional release coatings. In particular, a peel release force associated with cold seal release layer 120 is between 1-75 grams/inch, more preferably between 5-50 grams/inch, and most preferably about 10 grams/inch. In addition, the polyethylene cold seal release layer 120 has an effective coefficient of friction and advantageous surface energy characteristics, particularly in connection with the preferred film flow food packaging application. More specifically, the kinetic coefficient of friction should range between 0.200-0.450, preferably about 0.250-0.350, and most preferably about 0.300, while the static coefficient of friction should range between 0.210-0.650, preferably about 0.300-0.400, and most preferably about 0.350 (note coefficient of friction established according to ASTM D1894). In addition, the surface energy (using ASTM D2578 Standard Test Method) is in the range of 40-46 dyne/cm2.

Although described with reference to preferred embodiments of the invention, it should be understood that various changes and/or modification can be made without departing from the invention. For instance, the overall film sheet can include one or more additional polyethylene layers, such as interconnected by one or more additional tie layers.

1. A polyethylene cold seal film comprising:
a main body layer constituted by a polyethylene film;
a cold seal adhesive externally exposed on one side of the main body layer; and
a cold seal release layer externally exposed on an opposing side of the main body layer, said cold seal release layer also being constituted by a polyethylene film,
wherein the polyethylene cold seal film is essentially void of any polypropylene polymers and is entirely, readily recyclable.

2. The polyethylene cold seal film of claim 1, wherein the main body layer has a thickness in the range of 60-200 gauge.

3. The polyethylene cold seal film of claim 2, wherein the cold seal release layer has a thickness in the range of 60-130 gauge.

4. The polyethylene cold seal film of claim 1, wherein the main body layer is formed of oriented polyethylene (OPE), biaxially oriented polyethylene (BOPE), machine direction oriented polyethylene (MDOPE), Blown PE or Cast PE.

5. The polyethylene cold seal film of claim 4, wherein the cold seal release layer is formed of oriented polyethylene (OPE), biaxially oriented polyethylene (BOPE) or machine direction oriented polyethylene (MDOPE), Blown PE or Cast PE.

6. The polyethylene cold seal film of claim 1, further comprising a tie layer positioned between the main body layer and the cold seal release layer.

7. The polyethylene cold seal film of claim 6, further comprising:
a barrier layer positioned between the main body layer and the tie layer; and
an ink layer positioned between the tie layer and the cold seal release layer.

8. The polyethylene cold seal film of claim 7, wherein the barrier layer is formed of aluminum, aluminum oxide, silicon oxide, ethylene vinyl alcohol and/or polyvinyl alcohol.

9. The polyethylene cold seal film of claim 1, wherein the polyethylene cold seal film is completely void of polypropylene.

10. A roll of film formed from the polyethylene cold seal film of claim 1.

11. A package formed from the polyethylene cold seal film of claim 1, with the package enveloping a food product.

12. A packaging system comprising:
a roll configured to dispense a continuous sheet of flexible film, wherein said sheet of flexible film is a polyethylene cold seal film comprising: a main body layer constituted by a polyethylene film; a cold seal adhesive externally exposed on one side of the main body layer; and a cold seal release layer externally exposed on an opposing side of the main body layer, said cold seal release layer also being constituted by a polyethylene film, wherein the polyethylene cold seal film is essentially void of any polypropylene polymers and is entirely, readily recyclable;
a first seal assembly configured to seal overlapping longitudinal edge portions of the sheet of flexible film to create a tubular package; and
a second seal assembly configured to create a first end seal for the tubular package; and
a third seal assembly configured to create a second end seal to establish a sealed package.

13. The packaging system of claim 12, wherein the sealed package is configured to envelop a food product.

14. The packaging system of claim 12, wherein the main body layer has a thickness in the range of 60-200 gauge.

15. The packaging system of claim 14, wherein the cold seal release layer has a thickness in the range of 60-130 gauge.

16. The packaging system of claim 12, further comprising a tie layer positioned between the main body layer and the cold seal release layer.

17. The packaging system of claim 16, further comprising:
a barrier layer positioned between the main body layer and the tie layer; and
an ink layer positioned between the tie layer and the cold seal release layer.

18. The packaging system of claim 17, wherein the barrier layer is formed of aluminum, aluminum oxide, silicon oxide, ethylene vinyl alcohol and/or polyvinyl alcohol.

19. The packaging system of claim 12, wherein an entirety of the polyethylene cold seal film is completely void of polypropylene.

20. A method of packaging a product in flexible film package comprising:
drawing a sheet of flexible film from a roll, wherein said sheet of flexible film is a polyethylene cold seal film comprising: a main body layer constituted by a polyethylene film; a cold seal adhesive externally exposed along one side of the main body layer; and a cold seal release layer externally exposed on an opposing side of the main body layer, said cold seal release layer also being constituted by a polyethylene film, wherein the polyethylene cold seal film is essentially void of any polypropylene polymers and is entirely, readily recyclable; and
sealing at least one product within the sheet of flexible film by joining the polyethylene cold seal film to itself along longitudinal and end seals with the cold seal adhesive to establish a packaged product.

21. The method of claim 20, wherein an entirety of the polyethylene cold seal film is completely void of polypropylene.
